(19) United States
(12) Patent Application Publication
(10) Pub. No.: US 2008/0120357 A1
(43) Pub. Date: May 22, 2008

(54) Software method for solving systems of linear equations having integer variables

(76) Inventor: Jean-Paul Theis, Erpeldange (LU)

Correspondence Address: Jean-Paul Theis, Porte des Ardennes, 1, Erpeldange, L-9145, omitted

(21) Appl. No.: 11/603,055

(22) Filed: Nov. 22, 2006

(51) Int. Cl. G06F 17/11

(52) U.S. Cl. 708/446

(57) ABSTRACT

This invention describes a software method for computers for solving integer programming problems containing systems of linear equations where part of or all of the variables may take only integer values. Said software method consists of 4 main steps. First, all of or part of said system is transformed into a regularized system. In a second step, the regularized system is further transformed into an ordered system. In a third step, the regularized and ordered system is further transformed into a non-interfering system. In a last step, solutions to said system are determined by finding solutions which are common to all equations of said system. This is done by using a successive and recursive approximation algorithm. Finally, prior to executing said 4 steps, said system may have to be conditioned such every variable-coefficient of the system is non-zero.

U.S. patent application Ser. No. 11/412,135 serves as priority for the present invention.

### 1. FIELD OF THE INVENTION

This invention describes a software method for computers for solving integer programming problems containing systems of linear equations where part of the variables may take only integer values. Integer programming has many different practical applications, e.g. in production cost optimization, product development, logistics and business methods, in constructing and detecting arbitrarily large prime numbers for cryptographic applications.

### 2. PRIOR ART

Integer programming is a special case of linear programming where the variables (or unknowns) can take only integer values. Whereas efficient algorithms for linear programming has been developed as early as 1950, e.g. the simplex algorithm, integer programming appeared far more hard to implement efficiently. In average, the simplex algorithm has polynomial complexity. The complexity of an algorithm is measured in terms of basic operations the algorithm has to execute in order to solve a problem. Polynomial complexity means that the number of operations grows like O((n·k)^{c}), where O( ) denotes the mathematical sign for ‘order of magnitude’, n denotes the number of variables and k denotes the number of equations, and c is a constant whose value does not depend on n.

For integer programming, no polynomial complexity algorithm is known. State-of-the-art algorithms include branch-and-bound methods, cutting plane (Gomory) methods and explicit/implicit enumeration methods. All of these algorithms have exponential complexity and have an unacceptable run-time for optimization problems involving a few thousand variables.

Integer programming has numerous practical applications. One of the most famous is the traveling sales man problem where a salesman has to visit a certain number of clients at different locations within a given period of time. The underlying optimization problem consists in finding the optimal route such the clients visited within the given time are maximized. The traveling sales man problem can be generalized to other optimization problems common in logistics and transportation, which is also closely related to business methods for logistic and transportation companies.

Another field of applications of integer programming is that of production line optimization. E.g. consider a robot-controlled production line consisting of a number of robots able to assemble a certain number of products. Each product requires a different number of assembly steps on each robot. The underlying optimization problem consists in distributing the assembly steps of each product to the different robots such that the total number of assembly steps, e.g. the production costs, are minimized and the total number of products assembled in a certain time, e.g. the sales revenues, are maximized.

Another important field of application is product development, in particular chip design in the semiconductor industry. Chip design requires electronic design automation (EDA) tools for placement and routing of the semiconductor devices, e.g. transistors or logic gates, on a silicon die. A common flavor of the underlying optimization problem often consists in placing and routing the transistors on the silicon die in such a way that the total area occupied by the transistors is minimized and the sum of all wires connecting the transistors with each other is minimized. Part of this optimization problem can be formulated in the form of an integer programming problem where part of the integer variables are the coordinates of each transistor to be placed on the silicon die.

Another important field of application are cryptographic systems relying on large prime numbers in order to encrypt and decrypt messages and information. An efficient algorithm for integer programming allows to construct and detect arbitrarily large prime numbers efficiently.

### 3. DETAILED DESCRIPTION OF THE INVENTION

The present invention describes a novel and efficient algorithm for integer programming. The description of the invention aims at keeping the burden of mathematical notation and formalism at a minimum and giving, wherever possible, the priority to small and constructive examples from which the formal algorithm becomes obvious.

Consider the integer minimization problem consisting of a system of k linear equations of the form a_{1,l}·x₁+ . . . +a_{n,l}·xₙ=bₗ, l=1, . . . k, having n binary variables xₘ m=1 . . . n, coupled to an objective function min Σ_{m=1 . . . n} cₘ·xₘ. The coefficients a_{j,l}, cⱼ and bₗ, j=1, . . . n, l=1, . . . k, belong to the set of positive and negative integers. Each binary variable xₗ l=1 . . . n can take the value 0 or 1. For notational convenience, the coefficients a_{j,l} j=1, . . . n, l=1, . . . k will be called ‘variable-coefficients’.

By definition, a solution s of an equation or to the whole system is a set containing all those variables having a ‘1’ as value in that solution, e.g. s:={xₘ, m=1 . . . n|xₘ=1 and for l=1, . . . k: a_{1,l}·x₁+ . . . +a_{n,l}·xₙ=bₗ}.

The complexity of the algorithm is given in terms of the following basic operations (or steps):
1. basic arithmetic and relational operators (e.g. multiplication ‘·’, addition ‘+’, subtraction ‘−’, division with or without rest ‘l’, bigger or equal to ‘>=’, smaller or equal to ‘<=’, equal to ‘=’, different from ‘≠’, element of ‘ε’, included in ‘⊂’, union ‘∪’) taking as arguments either coefficients, variable labels, or words of up to O(n·log n) bits
2. bitwise logical operators (e.g. bitwise AND, OR, NOT) taking as arguments words of up to O(n·log n) bits
3. read/write accesses to random access memories having O(n) entries and storing up to O(n·log n) bits per entry

Unless specified otherwise, ‘log’ denotes the logarithm of base 2. Furthermore, the relational operators (e.g. ‘<=’ and ‘<’) define a total order over negative and positive integers such that f. ex. −4<−3, −2<1 and 2<3 hold. In this way, ‘max’ and ‘min’ operators are also well defined over negative and positive integers.

Without loss of generality (w.l.o.g.), it is assumed that each binary variable xₗ l=1 . . . n has at least one non-zero coefficient a_{l,k} in one or more of the k equations. First, the above system is ‘conditioned’, e.g. the system is transformed into an equivalent system having only non-zero variable-coefficients. ‘Conditioning’ has complexity O(k·n). An algorithm for conditioning a given system is found at the end of this section.

The algorithm for solving the above integer minimization problem consists of 4 main steps. Although step 1 is part of U.S. patent application Ser. No. 11/412,135, the present invention describes a more efficient algorithm for implementing step 1.

The 4 main steps are as follows:
1. The conditioned system is transformed into a ‘regularized’ system. By definition, a system is called ‘regularized’ if and only if (iif) the coefficients a_{m,l} m=1, . . . n, l=1, . . . k satisfy the following conditions:
   a. for any m,n,i,j with m≠n, i≠j: if a_{m,i}=a_{n,i} then a_{m,j}=a_{n,j}
   b. for any m,n i,j with m≠n, i≠j: if a_{m,j≠a}_{n,i} then a_{m,j}=a_{n,j}
   c. for any m,n,: a_{m,n}≠0
‘Regularization’, e.g. the transformation of a conditioned system into an equivalent regularized system, has complexity bounded by O(k·n).
2. The regularized system is further transformed into an ordered system. By definition, a system is called ‘ordered’ iif the coefficients a_{m,l m=}1, . . . n, l=1, . . . k and the variables xₚ p=1 . . . n satisfy the following conditions:
   e. for any m,n,i,j with m≠n, i≠j: if a_{m,i}<a_{n,i} then a_{m,j}<a_{n,j}
   f. for any m,n: a_{m,n}≠0
   g. for any m,i,j with i≠j: if a_{m,i}<0 then a_{m,j}<0
   h. for any m,i,j with i≠j: if a_{m,i}>0 then a_{m,j}>0
This step has complexity bounded by O(k·n·log n).
3. The regularized and ordered system is further transformed into an non-interfering system. This step has complexity bounded by O(k·n).
4. Find all the solutions of the regularized, ordered and non-interfering system by using a successive and iterative approximation algorithm. Finally, an additional algorithm for keeping only the solutions which minimize the objective function is used.

Each step is now described in detail.

### Step 1: Transforming the Conditioned System into a ‘Regularized’ System

The k equations of the ‘conditioned’ system are labeled 1, . . . k, e.g. equation k meaning the k^{th} equation of the system. Consider any two equations i and j. We define two sets S1_{i,j} and S2_{i,j} as follows:
a variable xₘ belongs to S1_{i,j} iif one of the following 2 conditions is satisfied:
   a. a_{m,j}≠a_{l,i} for all lε{1, . . . n}, l≠m
   b. if a_{m,i}=a_{l,i} for some lε{1, . . . n}, l≠m then a_{m,j}≠a_{l,j}
S2_{i,j} contains all other variables

It is useful to note that S1_{i,j}≡S1_{j,i} and S2_{i,j}≡S2_{j,i}. Determining S1_{i,j} has complexity bounded by because O(n²) pair-wise comparisons between coefficients are required.

Example: Consider two equations i,j:

−3·x₁−4·x₂+2·x₃+x₄+7·x₅−4·x₆+2·x₇=−3 i

x₁−3·x₂+2·x₃+x₄−5·x₅−3·x₆+2·x₇=−1 j
S1_{i,j}={x₁, x₄, x₅} S2_{i,j}={x₂, x₃, x₆, x₇}

End of example.

### Theorem 1:

Consider any two equations i,j with their sets S1_{i,j} and S2_{i,j}. There exist two integers a, b such that if equation i is substituted by the sum of equation i multiplied by a and of equation j multiplied by b, then:
1. all variables belonging to the set S1_{i′,j} of substituted equation i′ and equation j have pair-wise different and non-zero coefficients
2. all variables belonging to the set S2_{i′,j} have non-zero coefficients in equation i′ and equation j.

Finding the integers a, b has complexity bounded by O(n).

### Proof and Algorithm:

For notational convenience, we denote temporarily the variable-coefficients of equations i,j by c_{l,i} and c_{l,j} for l=1, . . . n respectively. The integers a, b must be such that:
for any m, l with l≠m for which the coefficients c_{l,i}, c_{l,j}, c_{m,i} and c_{m,j} belong to S1_{i,j}:

a·c_{l,i}+b·c_{l,j}≠a·c_{m,i}+b·c_{m,j}

[symbol]

a·(c_{l,i}−c_{m,i})≠−b·(c_{l,j}−c_{m,j})

[symbol]

a≠−b(c_{l,j}−c_{m,j})/(c_{l,i}−c_{m,i}) (1)
for any l=1, . . . n:

a·c_{l,j}+b·c_{l,j}≠0

[symbol]

a≠−b·c_{l,j}/c_{l,i} (2)

There are at most ½·(n−1)·n inequalities of type (1) and at most n inequalities of type (2). a and b have to be chosen such that these inequalities are satisfied. The definition of S1_{i,j} ensures that for each inequality of type (1), either (c_{l,j}−c_{m,j})≠0 or (c_{l,i -c}_{m,i})≠0 (or both). Furthermore, it is clear that those inequalities of type (1) for which (c_{l,i}−c_{m,i})=0 is satisfied if a ≠0. The inequalities of type (1) can be satisfied by setting b=−1, setting the denominator to 1, computing the absolute value (denoted by K) of the difference between the biggest and smallest coefficient in equation j, and setting a=K+1. We proceed in the same way to satisfy the inequalities of type (2). This yields a complexity of O(n). □

The theorem may also be applied to the substituted equation i′ and equation j to determine another pair of integers a′, b′ in order to substitute equation j by the sum of equation i′ multiplied by a′ and of equation j multiplied by b′ such that all the variables appearing in the substituted equation j′ and belonging to set S1_{i′,j′} have pair-wise different and non-zero coefficients.

Furthermore, the definition of set S2_{i′,j′} implies that the coefficients of the variables belonging to set S2_{i′,j′} satisfy:
if a_{m,i′=a}_{l,i′} for some m,lε{1, . . . n}, l≠m then a_{m,j′}=a_{l,j′}.

Example:

The previous example shall illustrate how the theorem works in practice.

−3·x₁−4·x₂+2·x₃+x₄+7·x₅−4·x₆+2·x₇=−3 i

x₁−3·x₂+2·x₃+x₄−5·x₅−3·x₆+2·x₇=−1 j
S1_{i,j}={x₁, x₄, x₅} S2_{i,j}={x₂, x₃, x₆, x₇}

Writing down all inequalities of type (1) yields:

a·(−6)≠b·(−6)

a·(−4)+≠0

a·(−10)≠b·(−6)

Writing down all inequalities of type (2) yields:

a·(−3)+b≠0

a·(−4)+b·(−3)≠0

a·2+b·2≠0

a+b≠0

a·7+b·(−5)≠0

a·(−4)+b·(−3)≠0

a=1, b=2 is one possible solution and leads to the following substituted equation i′:

−x₁−10·x₂+6·x₃+3·x₄−3·x₅−10·x₆+6·x₇=−5 i

x₁−3·x₂+2·x₃+x₄−5·x₅−3·x₆+2·x₇=−1 j
S1_{i′,j}={x₁, x₄, x₅} S2_{i′,j}={x₂, x₃, x₆, x₇}

Applying the same theorem to equations i′ and j in order to substitute equation j yields for example a′=−1, b′=2. The substituted equations i′ and j′ are displayed in rearranged variable order such that the structure of the sets S1_{i′,j′} and S2_{i′,j′} becomes apparent.

$$S {2}_{{i}^{′} , {j}^{′}} = \{ {x}_{2} , {x}_{3} , {x}_{6} , {x}_{7} \} S {1}_{{i}^{′} , {j}^{′}} = \{ {x}_{1} , {x}_{4} , {x}_{5} \}$$

$${i}^{′} \text{:} - \overbrace{10 \cdot {x}_{2} - 10 \cdot {x}_{6} + 6 \cdot {x}_{3} + 6 \cdot {x}_{7}} - \overbrace{{x}_{1} + 3 \cdot {x}_{4} - 3 \cdot {x}_{5}} = - 5$$

$${j}^{′} \text{:} 4 \cdot {x}_{2} + 4 \cdot {x}_{6} - 2 \cdot {x}_{3} - 2 \cdot {x}_{7} + 3 \cdot {x}_{1} - {x}_{4} - 7 \cdot {x}_{5} = 3$$

Equations i′ and j′ form a regularized system because, by definition, set S1_{i′,j′} satisfies condition b. and set S2_{i′,j′} satisfies condition a. of a regularized system and because all variable-coefficients are non-zero.

End of example.

The above procedure for transforming a conditioned system of two equations i,j into a regularized system can be extended to a conditioned system containing an arbitrary number of equations:
1. Apply theorem 1 to the first and second equation of the system in order to get a first equation substituted for the first time (denoted by 1_{—}1) and a set S1₁_{_{—}}_{1,2} and a set S2₁_{_{—}}_{1,2}, then apply the theorem to equation 1_{—}1 and the 3^{rd} equation of the system in order to get a first equation substituted for the second time (denoted by 1_{—}2) and a set S1₁_{_{—}}_{2,3}⊃S1₁_{_{—}}_{1,2} and a set S2₁_{_{—}}_{2,3}⊂S2₁_{_{—}}_{1,2}, then apply the theorem to equation 1_{—}2 and the 4^{th} equation system in order to get a first equation substituted for the third time (denoted by 1_{—}3) and a set S1₁_{_{—}}_{3,4} ⊃S1₁_{_{—}}2,3 and a set S2₁_{_{—}}_{3,4}⊂S2₁_{_{—}}_{2,3} . . . and so on, until the theorem is applied to equation 1_(k−2) and the k^{th} equation in order to get a first equation substituted for the (k−1)^{th} time (denoted by 1_(k−1)) and a set S1₁_{_{—}}_{(k-1),k}⊃S1₁_{_{—}}_{(k-2),k-1} and a set S2₁_{_{—}}_{(k-1),k}⊂S2₁_{_{—}}_{(k-2),k-1}. We define the set S1ₘₐₓ:=S1₁_{_{—}}_{(k-1),k} and the set S2ₘᵢₙ:=S2₁_{_{—}}_{(k-1),k}.
2. Apply the theorem to equation 1_(k−1) and the second equation to get a substituted second equation (denoted by 2_{—}1) having a set S1₁_{_{—}}_{(k-1),2}_{_{—}}₁=S1ₘₐₓ and a set S2₁_{_{—}}_{(k-1),2}_{_{—}}₁=S2 min, then apply the theorem to equation 1_(k−1) and the third equation to get a substituted third equation (denoted by 3_{—}1) having a set S1₁_{_{—}}_{(k-1),3}_{_{—}}₁=S1ₘₐₓ and a set S2₁_{_{—}}_{(k-1),3}_{_{—}}₁=S2ₘᵢₙ . . . and so on, until the theorem has been applied to equation 1_(k−1) and the k^{th} equation to get a substituted k^{th} equation (denoted by k_{—}1) having a set S1₁_{_{—}}_{(k-1),k}_{—1}=S1ₘₐₓ and a set S2₁_{_{—}}_{(k-1),k}_{_{—}}₁=S2ₘᵢₙ

Since the substitution of an equation has complexity O(n) and since 2·k substitutions have to be done, the total complexity of the procedure is O(k·n).

Example:

An example with 3 equations shall illustrate the sequence of substitutions. Equations i and j are taken from the previous example.

−3·x₁−4·x₂+2·x₃+x₄+7·x₅·4·x₆+2·x₇=−3 i

x₁3·x₂+2·x₃+x₄−5·x₅−3·x₆+2·x₇=−1 j

5·x₁−x₂+2·x₃+4·x₄−3·x₅−9·x₆+2^{·x}₇=0 k

First, the theorem is applied to equations i and j in order to substitute equation i by equation i_{—}1 in the same way as for the previous example with 2 equations, which yields the following system:

−x₁−10·x₂+6·x₃+3·x₄−3·x₅−10·x₆+6·x₇=−5 i_{—}1

x₁−3·x₂+2·x₃+x₄−5·x₅−3·x₆+2·x₇=−1 j

5·x₁−x₂+2·x₃+4·x₄−3·x₅−9·x₆+2·x₇=0 k

In a second step, the theorem is applied to equations i_{—}1 and k in order to substitute equation i_{—}1 by the sum of equation k and equation i_{—}1, which yields the following system:

4·x₁−11·x₂+8·x₃+7·x₄−6·x₅−19·x₆+8·x₇=−5 i_{—}2

x₁−3·x₂+2·x₃+x₄−5·x₅−3·x₆+2·x₇=−1 j

5·x₁−x₂+2·x₃+4·x₄−3·x₅−9−x₆+2·x₇=0 k

In a third step, the theorem is applied to equations i_{—}2 and j in order to substitute equation j by the sum of equation i_{—}2 and equation j, which yields the following system:

4·x₁−11·x₂+8·x₃+7·x₄−6·x₅−19·x₆+8·x₇=−5 i_{—}2

5·x₁−14·x₂+10·x₃+8·x₄−11·x₅−22·x₆+10·x₇=−6 j_{—}1

5·x₁−x₂+2−x₃+4·x₄−3·x₅−9·x₆+2·x₇=0 k

In a last step, the theorem is applied to equations i_{—}2 and k in order to substitute equation k by the sum of equation i_{—}2 and equation k, which yields the following regularized system:

$$i\_ 2 : 8 \cdot {x}_{3} + 8 \cdot {x}_{7} + 4 \cdot {x}_{1} - 11 \cdot {x}_{2} + 7 \cdot {x}_{4} - 6 \cdot {x}_{5} - 19 \cdot {x}_{6} = - 5$$

$$j\_ 1 : 10 \cdot {x}_{3} + 10 \cdot {x}_{7} + 5 \cdot {x}_{1} - 14 \cdot {x}_{2} + 8 \cdot {x}_{4} - 11 \cdot {x}_{5} - 22 \cdot {x}_{6} = - 6$$

$$k\_ 1 : \underbrace{10 \cdot {x}_{3} + 10 \cdot {x}_{7}} + \underbrace{9 \cdot {x}_{1} - 12 \cdot {x}_{2} + 11 \cdot {x}_{4} - 9 \cdot {x}_{5} - 28 \cdot {x}_{6}} = - 5$$

$$S {2}_{min} = \{ {x}_{3} , {x}_{7} \} S {1}_{max} = \{ {x}_{1} , {x}_{2} , {x}_{4} , {x}_{5} , {x}_{6} \}$$

End of example.

The sets S2ₘᵢₙ and S1ₘₐₓ are common (identical) to all equations of a regularized system. Furthermore, these two sets will be left unchanged by the transformations of the steps 2 and 3 below. The set S2ₘᵢₙ may contain one or more pair-wise disjoint sub-sets of variables having identical coefficients. E.g. for the above regularized system with 2 equations, S2ₘᵢₙ={x₂, x₃, x₆, x₇} contains two subsets: {x₂, x₆} and {x₃, x₇}. If S2ₘᵢₙ has v elements, then S2 min contains at most up to └v/2┘ sub-sets. We denote by ID_{m,k} the set of variables in equation k of a regularized system having m as common (or identical) coefficient value. E.g., for the above regularized system with 2 equations, ID_{10,1}={x₂, x₆} ID6,1={x₃, x₇} ID_{4,2}={x₂, x₆} ID_{-2,2}={x₃, x₇}. A set ID_{m,k} will be called ‘identical-coefficient set’ in the following.

### Step 2: Transforming the Regularized System into a Regularized and Ordered System

### Theorem 2:

Consider any two equations i,j having pair-wise different and non-zero variable-coefficients a_{m,i} and a_{m,j} m=1, . . . n respectively. There exists an integer b such that if equation j is substituted by the sum of equation i multiplied by b and of equation j, then the variable-coefficients of equations i and substituted equation j′ satisfy the following conditions:
a. for any m,n,i,j′ with m≠n, i≠j′: if a_{m,i}<a_{n,i} then a_{m,j′}<a_{n,j′}
b. for any m,n: a_{m,n}≠0

Finding the integer b has complexity bounded by O(n·log n).

### Proof and Algorithm:

We use the same technique as for the proof of theorem 1. First, we sort the coefficients of equation i in ascending order, which requires O(n·log n) operations and which yields a list of sorted variable-coefficients which we denote by c_{l,i} l=1, . . . n, c_{1,i} being the smallest coefficient and c_{n,i} the biggest coefficient in that list. We reorder the coefficients of equation j into another list of coefficients d_{l,i} l=1, . . . n such that for any l=1, . . . n: c_{l,i} and d_{l,i} refer to the same variable. Condition a. requires that the integer b has to be chosen such as to satisfy the following n−1 inequalities:
for any mε{1 . . . n−1}:

b·c_{m,i}+d_{m,j}<b·c_{m+1,i}+d_{m+1,j}

[symbol]

b>−(d_{m+1,j}−d_{m,j})/(c_{m+1,i}−c_{m,i}) (5)

As in the proof of theorem 1, we may set the denominator in (5) equal to 1, compute the biggest possible absolute value (denoted by K) of the nominator and setting b=K+1. □

### Procedure for Transforming a Regularized System into a Regularized and Ordered System:

1. Apply theorem 2 to the first and second equation of the system which leads to a substituted second equation, then apply to theorem 2 to the first and third equation which leads to a substituted third equation . . . and so on until theorem 2 is applied to the first and last equation, which leads a substituted last equation

The system obtained after applying this first step does not necessarily satisfy conditions g. and h. of an ordered system. These conditions can easily be satisfied by applying the following step to the system obtained after the previous step:
2. take the equation, denoted by (equation label) p, having the biggest number of positive variable-coefficients; let a_{m,p} denote the smallest positive variable-coefficient of equation p; substitute any other equation q by the sum of equation p multiplied by integer b_{q} and of equation q, where b must satisfy b_{q}>=−a_{m,q}/a_{m,p};

Since the substitution of an equation has complexity O(n·log n) and since k substitutions have to be done, the total complexity of transforming a conditional system into an ordered system is O(k·n·log n). □

Example:

Given the above regularized system with 3 equations (reproduced for convenience):

$$i\_ 2 : 8 \cdot {x}_{3} + 8 \cdot {x}_{7} + 4 \cdot {x}_{1} - 11 \cdot {x}_{2} + 7 \cdot {x}_{4} - 6 \cdot {x}_{5} - 19 \cdot {x}_{6} = - 5$$

$$j\_ 1 : 10 \cdot {x}_{3} + 10 \cdot {x}_{7} + 5 \cdot {x}_{1} - 14 \cdot {x}_{2} + 8 \cdot {x}_{4} - 11 \cdot {x}_{5} - 22 \cdot {x}_{6} = - 6$$

$$k\_ 1 : \underbrace{10 \cdot {x}_{3} + 10 \cdot {x}_{7}} + \underbrace{9 \cdot {x}_{1} - 12 \cdot {x}_{2} + 11 \cdot {x}_{4} - 9 \cdot {x}_{5} - 28 \cdot {x}_{6}} = - 5$$

$$S {2}_{min} = \{ {x}_{3} , {x}_{7} \} S {1}_{max} = \{ {x}_{1} , {x}_{2} , {x}_{4} , {x}_{5} , {x}_{6} \}$$

We sort the coefficients of equation i_{—}2 in ascending order and reorder the variables of the other equations accordingly, which yields the following system:

−19·x₆−11·x₂−6·x₅+4·x₁+7·x₄+8·x₃+8·x₇=−5 i_{—}2

−22·x₆−14·x₂−11·x₅+5·x₁+8·x₄+10·x₃+10·x₇=−6 j_{—}1

−28·x₆−12·x₂−9·x₅+9·x₁+11·x₄+11·x₃+10·x₇=−5 k_{—}1

In order to get an ordered system, we have to apply theorem 2 to equations j_{—}1 and k_{—}1 in order to substitute equation k 1 by equation k_{—}2 such that the resulting system is ordered. Applying theorem 2 yields b=2. This leads to the following regularized and ordered system:

−19·x₆−11·x₂−6·x₅+4·x₁+7·x₄+8·x₃+8·x₇=−5 i_{—}2

−22·x₆−14·x₂−11·x₅+5·x₁+8·x₄+10·x₃+10·x₇=−6 i_{—}2

−72·x₆−40·x₂−31·x₅+19·x₁+27·x₄+30·x₃+30·x₇=−17 k_{—}2

End of Example

### In general, it is clear that, for any ordered system, we may always rename the variables such that the variable labels are also sorted in the same order as the coefficients.

### Step 3. Transforming the Regularized and Ordered System into a Non-Interfering System

### Definition:

For any equation k of a regularized and ordered system, two sets ID_{m1,k} and ID_{m2,k} are said to interfere iif there exist integers pε{1, . . . |ID_{m1,k}|} and qε{1, . . . . ID_{m2,k}|} such that p·m1=q·m2. Similarly, a set ID_{m,k} is said to interfere with the set S1ₘₐₓ iif there exists an integer pε{1, . . . |ID_{m,k}|} and a variable xᵣεS1ₘₐₓ such that p·m=a_{r,k}, a_{r,k} being the coefficient associated to variable x, in the regularized and ordered system.

### Definition:

A regularized and ordered system is called ‘non-interfering’ iif in any equation of the regularized and ordered system there are no two identical-coefficient sets which interfere and no identical-coefficient set interfering with the set S1ₘₐₓ of the system.

In order to transform a regularized and ordered system into a non-interfering system, we have to extend theorem 1 as follows:

### Theorem 1a:

Consider any two equations i,j with their sets S1_{i,j} and S2_{i,j}. There exist two integers a, b such that if equation i is substituted by the sum of equation i multiplied by a and of equation j multiplied by b, then the following conditions are satisfied:
1. all variables belonging to the set S1_{i′,j} of substituted equation i′ and equation j have pair-wise different and non-zero coefficients
2. all variables belonging to the set S2_{i′,j} have non-zero coefficients in equation i′ and equation j.
3. no two identical-coefficient sets of equation i′ interfere
4. no identical-coefficient set of equation i′ interferes with set S1_{i′,j}

Finding the integers a, b has complexity bounded by O(n).

### Proof and Algorithm:

We apply the same technique as for the proof of theorem 1. As before, we denote temporarily the coefficients of equations i,j by c_{l,i} and c_{l,j} for l=1, . . . n respectively. We denote by SC2_{i,j,k} the set of all pair-wise different variable-coefficients in equation k which are associated to variables of S2_{i,j}. We translate the additional conditions 3. and 4. into additional inequalities as follows:
for any m1=c_{l1,i}εSC2_{i,j,i}, for any m2=c_{l2,i}εSC2_{i,j,i} with m1≠m2
for any pε{1, . . . |ID_{m1,i}|}, for any qε{1, . . . |ID_{m2,i}|}:

p·(a·c_{l1,i}+b·c_{l1,j})≠q·(a·c_{l2,i}+b·c_{l2,j})

[symbol]

a≠−b·(p·c_{l,1,j}−q·c_{l2,j})/(p·c_{l1,i}−q·c_{l2,i}) (3)
for any m1=c_{l1,i}εSC2_{i,j,i}
for any pε{1, . . . |ID_{m1,i}|}, for any variable xᵣεS1_{i,j}:

p·(a·c_{l1,i}+b·c_{l1,j})≠a·c_{r,i}+b·c_{r,j}

[symbol]

a≠−(p·b·c_{l1,j}−b·c_{r,j})/(p·c_{l1,i}−c_{r,l}) (4)

There are at most n²/2 inequalities of type (3) and at most O(n²) inequalities of type (4). As in the proof of theorem 1, these inequalities may be satisfied by setting b=1, setting the denominators in (3) and (4) to 1, computing the biggest possible absolute value (denoted by K) of the nominators in inequalities (3) and (4), and setting a=K+1. It is straightforward to verify that computing the biggest possible absolute values of the nominators in (3) and (4) has complexity O(n). □

It is clear that the transformation into a non-interfering system leaves unchanged the sets S1ₘₐₓ and S2ₘᵢₙ. Furthermore, we can now apply the same procedure as for transforming a conditioned system into a regularized system by using theorem 1a instead of theorem 1 in order to transform a regularized and ordered system containing an arbitrary number of equations into a non-interfering system. This leads to a total complexity of O(k·n) for step 3.

### Step 4. Finding all the Solutions of the Regularized, Ordered and Non-Interfering System by Using a Successive and Recursive Approximation Algorithm.

We first describe an algorithm which finds all solutions of a linear diophantine equation with binary variables having only pair-wise different and non-zero coefficients. The algorithm is then extended to an equation having one or more identical coefficients and positive or negative coefficients.

The working principle shall be illustrated by a small example. Consider some linear diophantine equation p of the regularized, ordered, non-interfering and conditional system of the form a_{1,p}·x₁+ . . . +a_{n,p}·xₙ=bₚ with n=11 binary variables having the following coefficients a_{i,p}i=1 . . . 11: 83, 55, 34, 30, 28, 11, 9, 7, 6, 3, 1. Note that, by virtue of an ordered system, each equation has its coefficients already sorted according to a same (ascending or descending) order. Wanted are all the solutions of the equation which are equal to the given number bₚ, e.g. bₚ=127.

For notational convenience, the variable-coefficients are renamed by cᵢ=a_{i,p} for i=1 . . . 1. For each coefficient cᵢ, we compute the set Σᵢ:=Σ_{m=i . . . n} cₘ, which requires O(n²) additions in total.

We define a sorted list Lₒ where the members of the list are labeled upwards from 1 to n. Member (with label) i of the sorted list Lₒ contains:
1. the associated coefficient cᵢ
2. the associated set Σᵢ
3. the label i of the associated variable xᵢ.

In the following algorithm specification, the steps are labeled by 1 . . . , 2 . . . , 3 . . . and have to be executed in the indicated order unless specified otherwise by a ‘goto’ statement.

### Single-Equation Algorithm:

1. set m′=m=flag=0; the stacks Lₕ and L_{S} are empty;
2. do a binary search among all subsequent members in the list L₀ (e.g. among members having labels >m′) to find the member with smallest label (e.g. with biggest associated coefficient), denoted by i, whose associated set Σᵢ satisfies Σᵢ>=bₚ and whose coefficient c; satisfies cᵢ<=bₚ;
3. if member i exists then goto step 4, else set flag=1 and goto step 7;
4. set bₚ=bₚ−cᵢ; store the label of the variable associated to member i together with the value of bₚ as a stack element on top of stack Lₕ; if bₚ=0, goto step 5, else goto step 6;
5. store all the elements of stack Lₕ to the stack of solutions L_{S};
6. set m′ equal to the label of the element stored on top of stack Lₕ; set bₚ equal to value of bₚ associated to that element; if bₚ=0 or if flag=1 then retrieve the element on top of stack Lₕ and set flag=0; goto step 2;
7. if stack Lₕ is empty, then set flag=0 and goto step 8, else goto step 6;
8. set m=m+1; set m′=m; if m′>n exit, else goto step 2;

It is useful to see it at work for the above example. For ease of illustration, we define one iteration of the algorithm as an up-piling after one or more consecutive de-pilings of the stack Lₕ. The iterations which are gone through by the algorithm for the above example with bₚ=127 are shown in the following table. The solutions are indicated by gray-shaded boxes. The arrows shall help to visualize the successive and recursive up- and de-piling of the stack Lₕ.

TABLE 1.1
2-dimensional up- and de-piling structure of the stack Lₕ

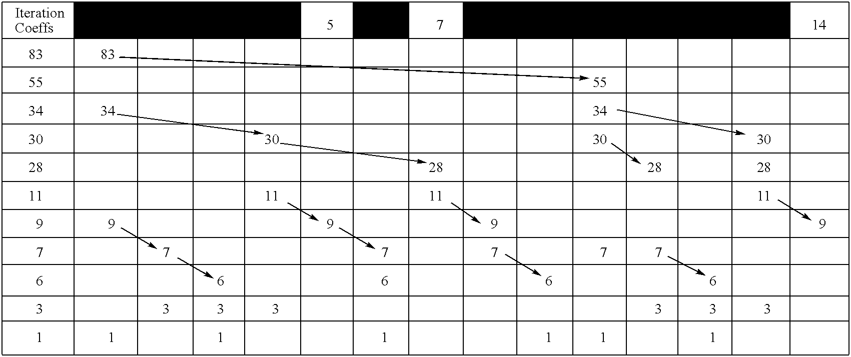

The working principle of the algorithm is based on a successive and recursive approximation of the given number bₚ with as less coefficients as possible: whenever a solution is found, a successive approximation is again applied to each coefficient of that solution, beginning with the smallest coefficient, which possibly generates a new solution for which a successive approximation is again applied . . . and so on, until all feasible approximations have been visited. The sets Σᵢ associated to each coefficient improve the efficiency for determining all feasible approximations by terminating an ongoing approximation as soon as Σᵢ<bₚ.

### 1. Extension to Identical Coefficients:

If there are m variables having identical coefficients of a same value v, then these m variables get temporarily replaced their m coefficients by the coefficients m·v, (m−1)·v, (m−2)·v . . . , 2·v, v. Since any solution can only involve at most one of these coefficients, as soon as and as long as one of these coefficients has been put onto the stack Lₕ, all other coefficients are ignored by subsequent searches. The rest of the algorithm remains unchanged. Any solution containing m·v as coefficient is a solution containing all of the m variables, a solution containing (m−1)·v as coefficient is a solution containing any m−1 pair-wise different variables selected from the m variables, a solution containing (m−2)·v as coefficient is a solution containing any m−2 pair-wise different variables selected from the m variables . . . and so on.

### Important Remark:

The extension to identical coefficients may lead to solutions containing parameterized sub-sets of the form of ‘m-out-of ID_{p,q}’, meaning that m pair-wise different variables have to be selected from identical-coefficient set ID_{p,q}. Note again that in a regularized system the identical-coefficient sets are common to (e.g. identical for) all equations of the system. Thus, the number of explicit solutions may be as large as (m·(m−1) . . . ·(m/2+1))/(m/2·(m/2−1) . . . ·1). In the following, the number m is called the ‘selection number’ of the parameterized sub-set m-out-of-ID_{p,q}. A solution containing a parameterized sub-set of the form of ‘m-out-of ID_{p,q} is called a parameterized solution.

### 2. Extension to Negative Coefficients

W.l.o.g. we assume that bₚ>0. The extension to negative coefficients requires:
to generate two sorted lists of coefficients, a first list containing all positive coefficients in descending magnitude order (biggest coefficient first), and a second list containing all negative coefficients in descending magnitude order (biggest negative coefficient first)
to concatenate the two sorted lists into a single list Lₒ by joining the end of the first list to the start of the second list
to compute the sum Σ₋ of all negative coefficients, the sum Σᵢ₊ of all positive coefficients in the first sorted list having labels >i, the sum Σᵢ₋ of all negative coefficients in the second sorted list having labels >i
to modify step 2 and to add step 2′ in order to distinguish between a binary search either within the range of positive or negative coefficients:
   2: if m′ denotes a positive coefficient, then do a binary search among all subsequent positive coefficients in the list Lₒ to find the member with smallest label, denoted by i, whose associated set Σᵢ₊ satisfies Σᵢ₊>=bₚ and whose coefficient cᵢ satisfies cᵢ<=bₚ−Σ₋; if member i does not exist, set m′ equal to the label of the first negative coefficient in the list; goto step 2′;
   2′: if m′ denotes a negative coefficient, then do a binary search among all subsequent negative coefficients in the list Lₒ to find the member with smallest label, denoted by i, whose associated set Σᵢ₋ satisfies Σᵢ<=bₚ and whose coefficient c; satisfies cᵢ>=bₚ;

Example:

An example with 7 positive and 4 negative coefficients for a given bₚ=95 is summarized in the following table. Contrary to this example (which aims at showing similarity to the previous example), the magnitude of one or more negative coefficients may be greater than the magnitude of one or more positive coefficients.

TABLE 1.2
Example of finding the solution of a linear equation with negative coefficients

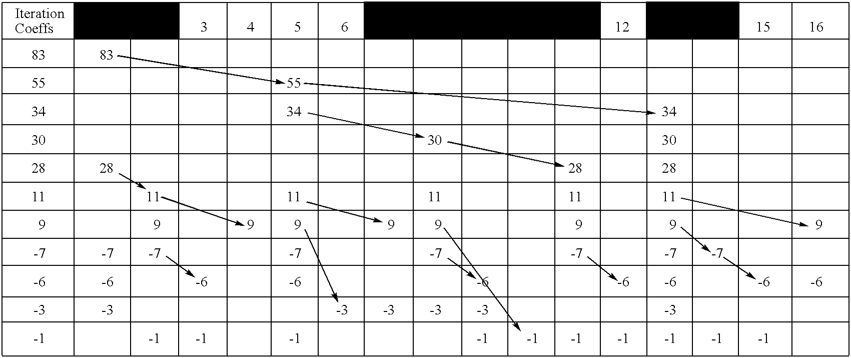

End of example.

Example:

The extensions to the algorithm can be applied to find all parameterized solutions to the following equation:

−10·x₂−10·x₆+6·x₃+6·x₇−x₁+3·x₄−3·x₅=−5

The 3 parameterized solutions of this equation are:

s₁={x₁, 1-out-of {x₂, x₆}, 1-out-of {x₃, x₇}}

s₂={x₁, 1-out-of {x₂, x₆}, 1-out-of {x₃, x₇}, x₄, x₅}

s₃={2-out-of {x₂, x₆}, 2-out-of {x₃, x₇}, x₄}

End of Example.

It is clear that a solution contains only those variables having a non-zero value. All other variables have a zero value.

The problem of finding solutions to a system containing two or more equations is equivalent to finding solutions which are common to all equations of the system. The following definition and theorem is straightforward.

### Definition and Theorem:

Consider any two equations i and j of the regularized, ordered, non-interfering and conditional system. A solution s is common to equations i and j iif there exists a solution sᵢ of equation i and a solution sⱼ of equation j such that sᵢ≡sⱼ≡s.

### Proof:

Due to the fact that all variable-coefficients of a regularized system are non-zero, it is impossible that there exists a solution sᵢ of equation i and a solution sⱼ of equation j such that sᵢ≠sⱼ and either sᵢ⊂sⱼ or sᵢ⊃sⱼ holds. Therefore, a solution s is common to both equations i and j iif sᵢ≡sⱼ≡s. □

### Important Remark:

Two parameterized solutions sᵢ and sⱼ are identical iif the following 3 conditions are satisfied:
a. the variables appearing in both solutions are identical
b. the parameterized sub-sets are pair-wise identical
c. the selection numbers of the parameterized sub-sets are pair-wise identical

Example:

A solution sᵢ={x₁, 1-out-of-{x₂, x₃, x₆}} is neither identical to s_{i={x>,} 1-out-of-{x₂, x₆}}, nor to sᵢ={x₁, 2-out-of-{x₂, x₃, x₆}}, nor to sᵢ={x₁, 1-out-of-{x₂, x₃, x₆}, x₇}.

End of example.

Next, we show how the successive and recursive approximation algorithm for finding all the solutions of a single linear diophantine equation can be extended to find all (common) solutions of an ordered system containing an arbitrarily large number of equations.

It is clear that, by definition of an ordered system, all equations have their coefficients already sorted according to a same (ascending or descending) order, as required by the successive and recursive approximation algorithm. The extension of the successive and recursive approximation algorithm to an ordered system of k equations, where each equation has only pair-wise different coefficients, is as follows:

Multi-equation algorithm: (modifications to the single-equation algorithm are in bold face)
1. set m′=m=flag=0; the stacks Lₕ and L_{S} are empty;
2. For each equation p of the system do:
   do a binary search among all subsequent members in the list L_{o, p} (e.g. among members having labels >m′) to find the member with smallest label (e.g. with biggest associated coefficient), denoted by rₚ, whose associated set Σᵣ_{ₚ} satisfies Σᵣ_{ₚ}>=bₚ and whose coefficient cᵣ_{ₚ} satisfies cᵣ_{ₚ}<=bₚ;
3. set r=maxₚ rₚ;
4. For each equation p of the system do:
   if member r of the list L_{o, p} is such that Σᵣ_{_{p>b}}ₚ then set flag=1 and goto step 10;
5. For each equation p of the system do: set bₚ=bₚ−cᵣ_{ₚ};
6. store the label of the variable associated to member r together with the k-tuplet (b₁, . . . , bₖ) as a stack element on top of stack Lₕ; if (b₁, . . . , bₖ)=(0, . . . , 0) then goto step 7, else goto step 8;
7. store all the elements of stack Lₕ to the stack of solutions L_{S};
8. set m′ equal to label of element stored on top of stack Lₕ; set the k-tuplet (b₁, . . . , bₖ) equal to the k-tuplet associated to that element; if (by b₁, . . . , bₖ)=(0, . . . , 0) or if flag=1 then retrieve the element on top of stack Lₕ and set flag=0; goto step 2;
9. if stack Lₕ is empty, then set flag=0 and goto step 10, else goto step 8;
10. set m=m+1; set m′=m; if m′>n exit, else goto step 2;

As before, it is useful to consider the multi-equation algorithm at work for an ordered system of 2 equations with b₁=127 and b₂=110 as shown in the following table. The system has no solution and the number of iterations is reduced substantially compared to the number of iterations required for finding the solutions of a single equation.

TABLE 1.3
Example of applying the successive and recursive algorithm to finding
solutions to a system of two linear diophantine equations

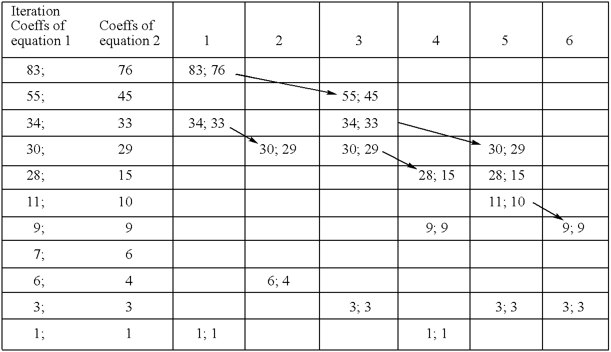

As can be seen from the modifications to the single-equation algorithm, the working principle of the multi-equation algorithm remains largely unchanged, except for step 3 which is not present in the single-equation algorithm. Since step 2. searches in every equation p of the system for the biggest possible coefficient (e.g. with smallest label) out of the sub-sequent coefficients of the list L_{o,p} to approximate bₚ, and by virtue of the previous definition and theorem, step 3. is required in order to select variable xᵣ as the next variable being part of a feasible solution common to all equations of the system.

### 1. Extension to Identical Coefficients:

The extension of the multi-equation algorithm to ordered systems of equations where an equation may have identical coefficients works only if the system is not only ordered, but additionally regularized and non-interfering, because regularization and non-interference guarantees that the set S2ₘᵢₙ remains unchanged and is common (identical) to all equations of the system. The extension of the multi-equation algorithm to such a system is identical to the extension of the single-equation algorithm to a single equation having identical coefficients. That is, if there are m variables having identical coefficients of a same value v, then these m variables get temporarily replaced their m coefficients by the coefficients m·v, (m−1)·v, (m−2)·v . . . , 2·v, v in the list L_{o, p} of equation p. Since any solution can only involve at most one of these coefficients, as soon as and as long as one of these coefficients has been put onto the stack Lₕ, all other coefficients are ignored by subsequent searches. The rest of the algorithm remains unchanged. Any solution containing m·v as coefficient is a solution containing all of the m variables, a solution containing (m−1)·v as coefficient is a solution containing any m−1 pair-wise different variables selected from the m variables, a solution containing (m−2)·v as coefficient is a solution containing any m−2 pair-wise different variables selected from the m variables . . . and so on.

### 2. Extension to Negative Coefficients

Since the variables having negative coefficients in any equation of an ordered system are exactly the same for all equations of the system, the extension of the multi-equation algorithm to systems of equations having negative coefficients is straightforward. (The modifications to the single-equation algorithm are in bold face.) W.l.o.g. we assume that for any equation p: bₚ>0

The extension to negative coefficients requires:
to generate, for each equation p of the system separately, two sorted lists of coefficients, a first list containing all positive coefficients in descending magnitude order (biggest coefficient first), and a second list containing all negative coefficients in descending magnitude order (biggest negative coefficient first)
to concatenate the two sorted lists into a single list L_{o, p} by joining the end of the first list to the start of the second list
to compute, for each equation p of the system separately, the following three sums: the sum Σₚ₋ of all negative coefficients, the sum Σ_{p, i+} of all positive coefficients in the first sorted list having labels >i, the sum Σ_{p,i-} of all negative coefficients in the second sorted list having labels >i
to modify step 2 and to add step 2′ in order to distinguish between a binary search either within the range of positive or negative coefficients:
   2: if m′ denotes a positive coefficient, then do a binary search among all subsequent positive coefficients in the list L_{o, p} to find the member with smallest label, denoted by rₚ, whose associated set Σ_{p,r}_{ₚ₊} satisfies Σ_{p,r}_{ₚ}₊>=bₚ and whose coefficient cᵣ_{ₚ} satisfies cᵣ_{ₚ}<=bₚ−Σₚ; if member cᵣ_{ₚ} does not exist, set m′ equal to the label of the first negative coefficient in the list; goto step 2′;
   2′: if m′ denotes a negative coefficient, then do a binary search among all subsequent negative coefficients in the list L_{o, p} to find the member with smallest label, denoted by rₚ, whose associated set Σ_{p,r}_{ₚ}₋ satisfies Σp,r_{_{p−}}<=bₚ and whose coefficient cᵣ_{ₚ} satisfies cᵣ_{ₚ}>=bₚ;

In order to solve the given integer minimization problem, once all the solutions of the regularized, ordered, non-interfering and conditional system have been computed with the extended multi-equation algorithm we retain only those solutions which minimize the objective function. For this purpose, we compute for each solution the corresponding value of the objective function as given by the minimization problem and we put these values together with their associated solutions into a list. This list is then sorted according to ascending objective function values. The solutions to be retained are the first elements of the list having the same objective function value

As mentioned before, solutions may be parameterized, e.g. they may contain parameterized sub-sets of the form of ‘m-out-of ID_{p,q}’, It should be noted that, when computing the objective function value for a parameterized solution, the parameterized sub-sets appearing in the solution may get modified their selection numbers and may even disappear. Furthermore, new parameterized sub-sets may appear.

Although the following algorithm is part of U.S. patent application Ser. No. 11/412,135, it is reproduced here for completeness. The algorithm computes the objective function value t for a parameterized solution s and how to compute all new parameterized sub-sets ssₖ and selection numbers uₖ of the ‘modified’ solution s’. The algorithm distinguishes between the original parameterized sub-sets of solution s and the new parameterized sub-sets of the modified solution s′. We may label the parameterized sub-sets and denote by lₚ the selection number of an original parameterized sub-set with label p.

In the following program notation, which is very similar to that of the programming language C++, the brackets { . . . } denote a group of statements to be executed sequentially. However, the brackets are also used to define and specify the empty set { } and the set {xₘ}.

### Algorithm:

1. Sort the coefficients cₘ (and associated variables) appearing in the objective function according to ascending coefficient values. If a coefficient appears several times in the list, then regroup the associated variables into a sub-set;
2. s′={ }; k=0; k′=0;
   For each coefficient cₘ (beginning with the first) in the sorted list do:

```
{ For each original sub-set p of solution s do :
    { if lₚ − qₚ > 0 then lₚ= lₚ − qₚ;
      else lₚ=0;
      qₚ=0; flagₚ =0;
    }
  k′ =k;
  For each variable xₘ of the sub-set associated to cₘ do :
    if xₘ∈s and xₘ belongs to an original sub-set p of solution s
    then { if flagₚ = 0 then { flagₚ =1;
                k=k+1;
                define a new sub-set ssₖ := { };
                define a new uₖ := 0;
              }
            if flagₚ = 1 then if lₚ > 0 then { qₚ = qₚ +1; uₖ=uₖ +1;
                      ssₖ = ssₖ ∪ { xₘ }
                    }
          }
      else if xₘ∈s then {s′ = s′∪ { xₘ }; t = t + cₘ ;}
  For each new sub-set ss_{J=k...k′}do :
    { s′= s′ ∪ uₖ -out-of- ssₖ ; t = t + uₖ· cₘ ;}
}
```

It is straightforward to verify that a new defined sub-set ssₖ can take its elements (e.g. variables) only from one original sub-set. The program variables uₖ, qₚ and flagₚ ensure that the sum of all variables of all those new sub-sets taken from a same original sub-set does not exceed the initial selection number lₚ of that original sub-set.

Example:

Given is an objective function to minimize t=min Σ_{m=1 . . . n} cₘ·xₘ=min −7·x₁−4·x₂+2·x₃+x₄−5·x₅−4·x₆+2·x₇ for a given parameterized solution s={x₁, 1-out-of-{x₂, x₆}, 2-out-of-{x₃, x₄, x₅}}.

Sorting the coefficients appearing in the objective function yields the following list: {(−7, x₁), (−5, x₅), (−4,{x₂, x₆}), (1, x₄), (2, {x₃, x₇})}. In this list, the 2 sub-sets {x₂, x₆} and {x₃, x₇} are associated to the coefficients −5 and 2 respectively.

Applying the previous algorithm leads to t=−15 and s′={x₁, 1-out-of-{x₂, x₆}, x₄, x₅}.

### Conditioning:

Considered is again the integer minimization problem from the beginning of this section. It is shown how the given system can be transformed into a conditioned system, e.g. a system having only non-zero variable-coefficients. Conditioning has complexity O(k·n²).

Instead of giving a formal algorithm, it is more instructive to give a small constructive example from which the formal procedure and algorithm becomes obvious.

E.g. consider the following system of 3 equations:

2·x₁+x₃−x₅=1 1

+5·x₂−x₃−x₄=0 2

−x₁−3·x₂+x₄+x₅=0 3

First, we substitute equation 1 by an equation 1′ having only non-zero variable-coefficients. For this purpose, we substitute equation 1 by a linear combination of equations 1, 2 and 3. This may be written formally as: 1′←a·1+b·2+c·3.

We have to determine the integers a, b and c such that all variable-coefficients of equation 1′ are non-zero. Since there are 5 variables, the integers a, b and c must satisfy at most 5 inequalities:

2·a−c≠0

5·b−3·c≠0

a−b≠0

−b+c+≠0

a+c≠0

In order to find a solution to these inequalities, we can start giving a an arbitrary non-zero value, e.g. a=1, and rewrite the 5 inequalities for a=1, which yields another 5 inequalities:

c≠2

5·b−3·c≠0

b≠1

b+c≠0

c≠1

There may appear at most 5 values to which b or c must be different. Therefore, we give b an arbitrary value which must be different to at most 5 values, e.g. we may choose b=2, and rewrite these inequalities for b=2, which yields another 5 inequalities:

c≠2

c≠10/3

b≠1

c≠2

c≠1

Finally, there may appear at most 5 values to which c must be different. Therefore, we may give c an arbitrary value which is different to these 5 values, e.g. by setting c equal to the biggest or smallest value of these 5 values added by 1, e.g. we may choose c=10/3+1=4.

Since the substituted equation 1′ has only non-zero variable coefficients, we can find integers d and e such that 2′←d·1′+e·2 and equation 2′ having only non-zero variable coefficients. The integers d and e are determined by proceeding in a similar way as before:
write down all 5 inequalities requiring that each variable coefficient of equation 2′ has to be non-zero
set d or e to an arbitrary non-zero value and obtain a list of at most 5 values to which d or e must be different
determine d or e by computing the biggest or smallest value (denoted by K) of these (at most) 5 values and set d or e equal to K+1

We proceed in the same way for equation 3.

Therefore, in the general case of a system of k linear diophantine equations and n binary variables, k-n basic operations are required in order to make all variable-coefficients of the first equation non-zero, and 2-k-n operations for all other equations. □

### Concluding Remarks:

It is clear that, if the given system of linear diophantine equations is regularized prior to applying main step 1, that this step can be skipped. Similarly, if the given system is ordered or non-interfering prior to applying main steps 2 or 3, then these steps can be skipped.

It is straightforward to verify that the algorithmic described by this invention remains valid in the case that the coefficients are non-integer numbers, but fractional, rational or floating-point numbers.

### 4. SUMMARY OF THE INVENTION

This invention describes a software method for computers for solving integer programming problems containing systems of linear equations where part of or all of the variables may take only integer values.

What is claimed is:

1. a software method for solving a system of linear equations having integer variables, where said method consists of doing one or more of the following 3 steps:
I. part of or all of said system is transformed into a regularized system
II. part of or all of said system is transformed into an ordered system
III. part of or all of said system is transformed into a non-interfering system

2. a software method as in claim 1, where said method consists of doing said 3 steps in the following order:
I. part of or all of said system is transformed into a regularized system
II. part of or all of the regularized system is transformed into a regularized and ordered system
III. part of or all of the regularized and ordered system is transformed into a non-interfering system

3. a software method as in claim 1, where said method consists of doing one of the following steps
a. part of or all of said system is transformed into a regularized and ordered system
b. part of or all of said system is transformed into a regularized and non-interfering system
c. part of or all of said system is transformed into an ordered and non-interfering system

4. a software method as in claim 1, where solutions to said system are determined by using a successive and recursive approximation algorithm

5. a software method as in claim 2, where solutions to said system are determined by using a successive and recursive approximation algorithm

6. a software method as in claim 3, where solutions to said system are determined by using a successive and recursive approximation algorithm

7. a software method as in claim 1, where prior to executing said method, said system is conditioned such that every variable-coefficient of the conditioned system is non-zero

8. a software method as in claim 2, where prior to executing said method, said system is conditioned such that every variable-coefficient of the conditioned system is non-zero

9. a software method as in claim 3, where prior to executing said method, said system is conditioned such that every variable-coefficient of the conditioned system is non-zero

10. a software method as in claim 4, where prior to executing said method, said system is conditioned such that every variable-coefficient of the conditioned system is non-zero

11. a software method as in claim 5, where prior to executing said method, said system is conditioned such that every variable-coefficient of the conditioned system is non-zero

12. a software method as in claim 6, where prior to executing said method, said system is conditioned such that every variable-coefficient of the conditioned system is non-zero
